(19) United States
(12) Patent Application Publication
(10) Pub. No.: US 2010/0007169 A1
(43) Pub. Date: Jan. 14, 2010

(54) Vehicle protection assembly

(76) Inventor: Trinh Anh Hieu Nguyen, Westminster, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/457,162

(22) Filed: Jun. 2, 2009

Related U.S. Application Data
(60) Provisional application No. 61/129,684, filed on Jul. 11, 2008.

(51) Int. Cl. B62D 25/00

(52) U.S. Cl. 296/136.07

(57) ABSTRACT

The vehicle protection assembly provides a plurality of protective vehicle shields which are magnetically, releasably attachable-to the painted surfaces of a vehicle for protecting the painted surfaces from external damage. The assembly is provided as a kit of the protective vehicle shields customized for a particular vehicle. Each of the protective vehicle shields is formed by injection molding a synthetic elastic material with a magnetic material mixed therein. Each protective vehicle shield is shaped to conform to a particular vehicle body.

### CROSS-REFERENCE TO RELATED APPLICATION

This application claims the benefit of U.S. Provisional Patent Application Ser. No. 61/129,684, filed Jul. 11, 2008.

### BACKGROUND OF THE INVENTION

1. Field of the Invention

The present-invention relates to a vehicle protection assembly that protects the painted surfaces of a motor vehicle body from damage.

2. Description of the Related Art

Parked vehicles in parking lots often receive dents, dings, scratches and other damage on their outer paint surfaces due to the carelessness of the owners of adjacent parked vehicles. The damage typically comes from a vehicle door of the adjacent vehicle being opened into, and colliding with, the parked vehicle. Contractors, construction workers and like also receive a lot of dents, dings, and scratches in the painted surfaces of their pickup trucks, but the damage to these painted surfaces does not necessarily come from the doors of adjacent parked vehicles. Instead, the damage comes from bricks, cement, tools, lumber, trash and other work site debris hitting the painted surfaces of the pickup truck while on a construction site.

Simple driving on a highway, a dirt road, a country road, a street or the like can also damage the painted surface of a vehicle via collision with pebbles, sand, rocks, branches, or other types of small projectiles which typically strike the painted surfaces of a driving vehicle. Thus, a vehicle protection assembly solving the aforementioned problems is desired.

### SUMMARY OF THE INVENTION

The vehicle protection assembly for protecting painted surfaces of a motor vehicle body from damage includes a plurality of protective vehicle shields. The shields are each magnetically attachable to the metal surfaces of the vehicle. Each of the shields is preferably formed by injection molding a synthetic elastic material with a magnetic material. The shield is then shaped and cut to conform to the shape of the painted surfaces of the motor vehicle body. The protective shield, when magnetically attached to the painted surface, covers the painted surface of the vehicle body when deployed.

The synthetic, elastic material from which the shields are made is preferably flexible, durable, and water-resistant. The shields of the vehicle protection assembly each include a front side and a rear side, with both sides being magnetic. Thus, the shields can be painted or have advertisements or other indicia formed thereon.

These and other features of the present invention will become readily apparent upon further review of the following specification and drawings.

### BRIEF DESCRIPTION OF THE DRAWINGS

FIG. 1 is an environmental, perspective view of a vehicle protection assembly according to the present invention.

FIG. 2 is an environmental, perspective view of a vehicle protection assembly according to the present invention.

FIG. 3 is a plan view of a kit of protective shields forming the vehicle protection assembly according to the present invention.

FIG. 4 is a section view along lines 4-4 of FIG. 3.

Similar reference characters denote corresponding features consistently throughout the attached drawings.

### DETAILED DESCRIPTION OF THE PREFERRED EMBODIMENTS

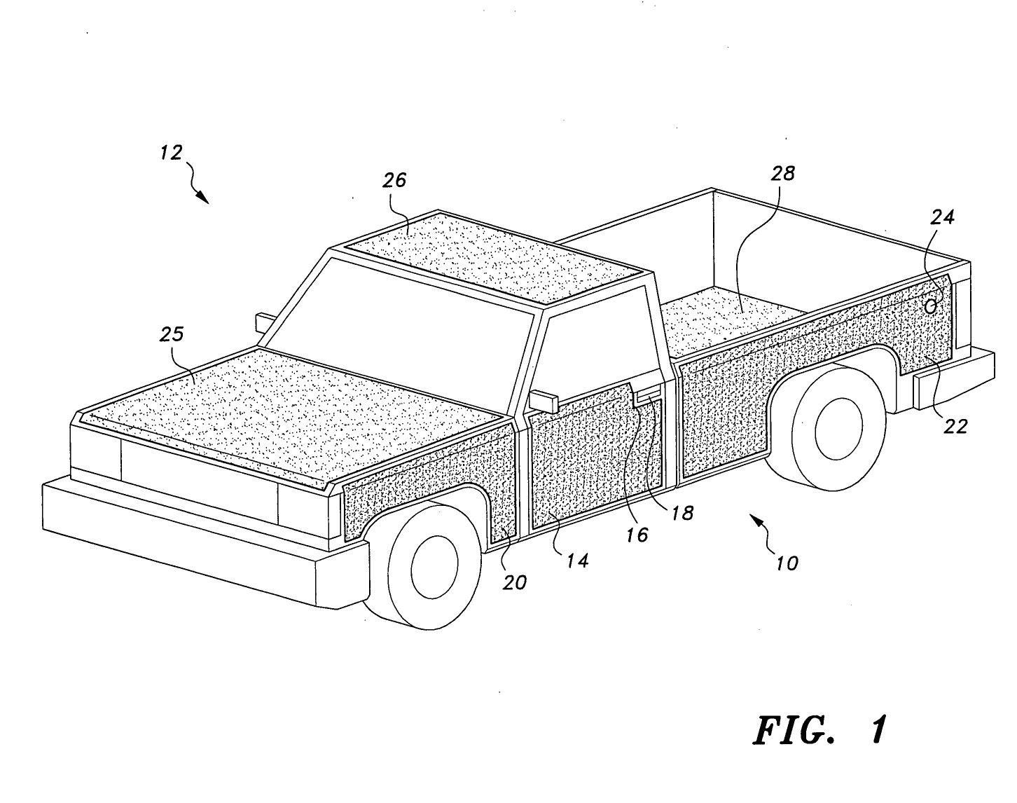

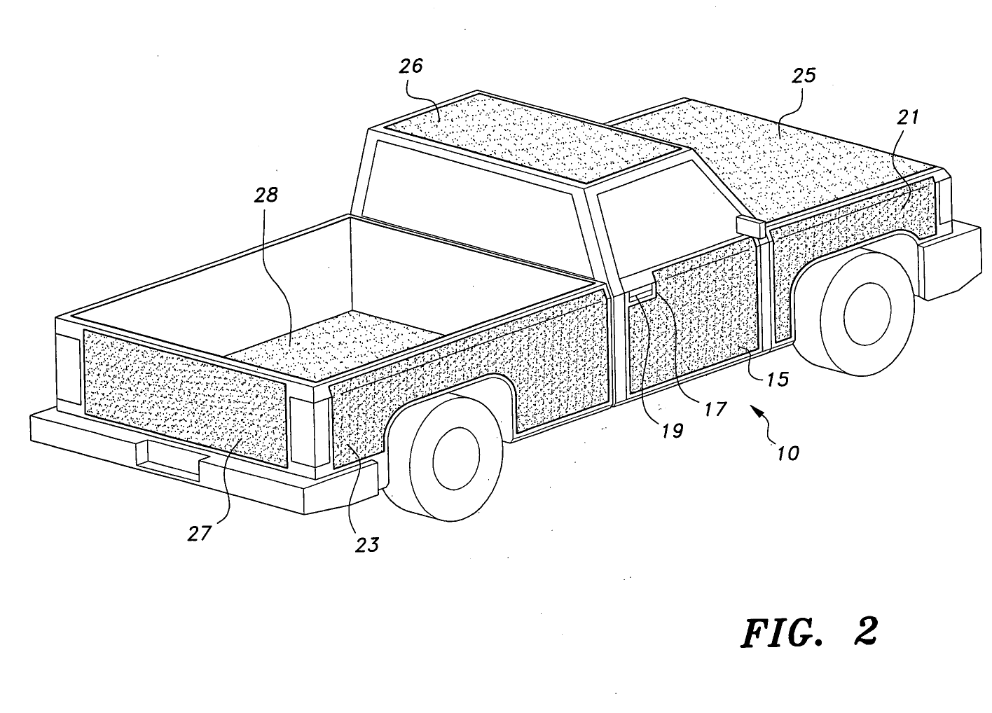

Now referring to FIGS. 1 and 2, there is shown a vehicle protection assembly 10 applied to an exemplary pickup truck 12. As will be described in greater detail below, the vehicle protection assembly 10 includes a plurality of separate vehicle protection shields which are secured to individual painted panels of the exterior of truck 12, thus providing protection therefor from external and environmental damage. As shown, the truck 12 has nearly all of its painted surfaces covered by the assembly 10, preferably with only the trim, windows, lights and other functional exterior elements of the truck 12 remaining uncovered. It should be understood that pickup truck 12 is shown for exemplary purposes only, and that assembly 10 may be applied to the exterior surfaces of any desired vehicle.

As shown in the front and rear perspective views of FIGS. 1 and 2, vehicle protection assembly 10 is a kit that includes a plurality of protective vehicle shields. The kit may include door shields 14, 15, which are dimensioned and configured to cover the door panels of pickup truck 12. Cutout portions 16, 17 on door shields 14, 15, respectively, leave door handles 18, 19 exposed when door shields 14, 15 are affixed to the doors of pickup truck 12. Cutout portions 16, 17 both expose the handles of the doors and also serve as guides for proper positioning of shields 14, 15 on the truck doors.

The kit may also contain front shields 20, 21 for covering the front panels or fenders over the front wheels of the pickup truck 12. The kit may further contain rear shields 22, 23 for covering the rear side panels of the truck bed over the rear wheels. As shown, rear shield 22 has a circular cutout 24 for exposing a gas tank access door. Cutout 24 may be formed through any of the applied shield panels, dependent upon the make and model of the vehicle. Similarly, it should be understood that the plurality of shield panels shown in the Figures are shown for exemplary purposes only. Kits of panels of the assembly 10 may be manufactured for individual makes, models and years of vehicles, including custom numbers of panels, and contouring and dimensions of the panels to properly cover a particular vehicle configuration.

The remaining shields shown in FIGS. 1 and 2 may cover specific single areas, as opposed to the paired areas described above. A hood shield 25 may be provided to cover the hood of the pickup truck 12, along with a top shield 26 for covering the top or roof of the cab of the pickup truck 12. Further, a tailgate shield 27 may be provided for covering the tailgate panel of the pickup truck 12.

In the exemplary vehicle protection assembly 10 for pickup truck 12, a bed shield 28 may further be provided, for covering the exposed bed of the rear portion of pickup truck 12. As noted above, the shield panels are preferably customized for the make, model, year and type of vehicle. The bed shield 28 is preferably formed as a thicker layer than the other vehicle protection shields in order to provide additional protection from additional loads that may be transported in the bed of the pickup truck 12.

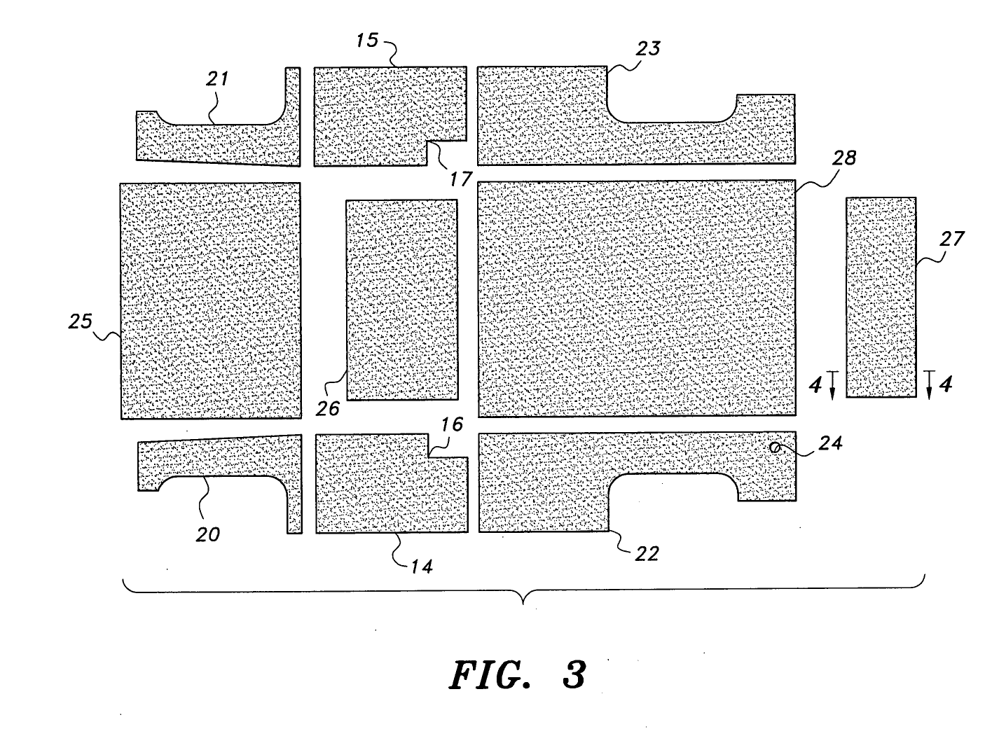

FIG. 3 is a plan view of the exemplary kit of protective shields forming the vehicle protection assembly 10 for pickup truck 12. The individual shields may be manufactured through any suitable process, such as, for example, injection molding of a synthetic, elastic material, such as, for example, neoprene or any other artificial rubber, mixed with a magnetic material. Alternatively, the composite material may be extruded and rolled out as a sheet. The extruded composite material can then be cut or trimmed in a shape to nearly cover a specific part of the painted surfaces of the vehicle body when deployed. It should be understood that any suitable type of cushioning, water-proof material may be utilized, such as, for example, synthetic leather, vinyl, synthetic rubber, nylon, or the like. Any suitable elastomeric, cushioning and protective material may be used.

The vehicle protection assembly 10 shields vulnerable, paramagnetic, painted surfaces of a vehicle from scrapes, chips, and abrasions caused by heavy brush, branches, sand storms, and harsh treatment while traveling on rough off-road terrain, or from any other external or environmental force which may damage the vehicle's paint. Additionally, the common collisions between vehicle doors of parked cars will be prevented from causing damage to the vehicle door's exterior paint when door shields 14, 15 are applied. It should be understood that the user may choose to apply any desired type or number of shield panels to his or her vehicle. For example, a user may choose to only apply the door shield panels 14, 15 to his or her vehicle.

Once assembly 10 has been applied to a vehicle, the vehicle may be driven off-road, used on a construction site, or be driven or parked in any potentially dangerous environment without the driver worrying about nicks and scratches in the paint job due to contact with brush, flying dirt, building materials, equipment, tree limbs and other hazards. Due to the magnetic nature of each individual shield panel, after use, the vehicle protection assembly 10 can be easily removed from the vehicle to expose a clean and flawless painted vehicle.

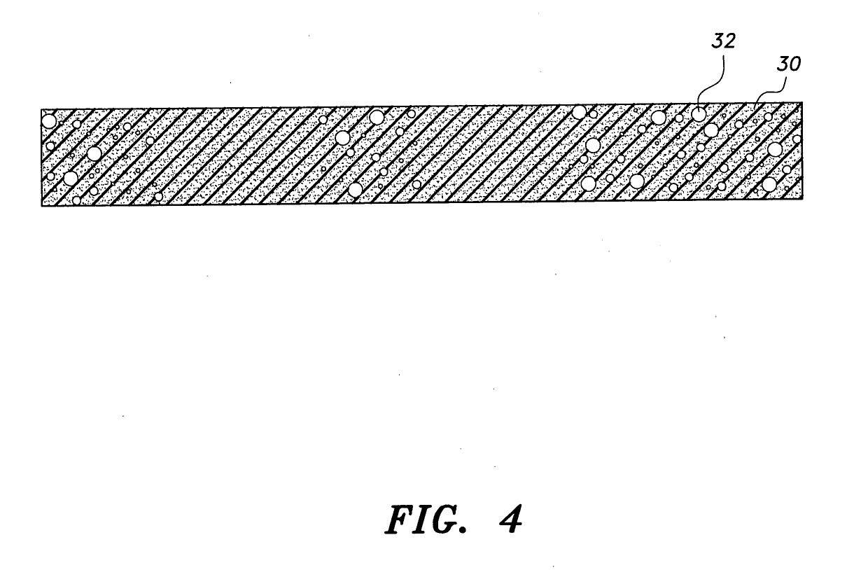

FIG. 4 illustrates the composition of a single protective shield of the overall assembly 10. Artificial rubber 30 and magnetized particles 32, as described above, may be injection molded into a three-dimensional shield panel to match a shape of a specific vehicle panel; e.g., the doors or fenders of a specific vehicle. Preferably, magnetized particles 32 are composed of a magnetic material that will not rust or otherwise corrode, such as powdered neodymium ferrite. It should be understood that any non-corrosive magnetic material may be used.

More specifically, an elastomer, such as neoprene, that has magnetized particles mixed into it when it is melted (i.e., when the neoprene is in liquid form) is subsequently injection molded into a three-dimensional shield panel to match the shape of a specific vehicle panel. Neoprene is a synthetic rubber material designed to act flexibly, durably, and to resist breakdown by water. Flat shields or panels up to an inch thick can also be made for truck beds. The inside walls of the bed could also be covered. It should be understood that any suitable elastomeric material that is water-resistant and resistant to external damaging forces may be used. Preferably, the elastomer is selected to be heat resistant, ultraviolet resistant, weather resistant, chemical resistant and resistant from damage when external forces, such as road projectiles or adjacent car doors, collide therewith. Additionally, any sort of magnetic particulate material may be used.

The outside surface of any of the shields or panels may be textured and painted after shaping and cutting, allowing for the formation of advertising or other indicia thereon. Customized designs, such as camouflage designs for hunting purposes, may be applied to the individual shields of assembly 10. Further, an external, ultraviolet-resistant material may be coated on the exterior faces of the panels. As shown in FIG. 4, the magnetized particles 32 are preferably evenly distributed throughout the elastomeric layer 30, thus allowing either surface of the shield panel to be affixed to the vehicle. Thus, the shields of the vehicle protection assembly 10 can have different color designs on either side thereof.

It should be understood that application of the shield panels is not limited to vehicles alone. For example, appliances such dishwashers, washing machines, dryers, and refrigerators, which are being transported can be covered with customized shield panels in order to protect these articles from dings, dents, and scratches during transport. The shield panels may be painted or otherwise covered to have a metallic appearance for appliances, such as, for example, the appearance of stainless steel, gold or silver, for example. Additionally, for a stovetop, for example, the panels may be formed from fire or heat resistant material. Such fire and heat resistant panels may be applied to stovetops, for example, in order to keep the stovetop clean during cooking, as the panels will protect the metal upper surface from splattered grease and the like.

Preferably, the shield panels are adapted so that they releasably adhere to the vehicle's exterior surface with a minimum of air or moisture being trapped therebetween. Additionally, it should be understood that a plurality of shield panels may be provided for covering a single portion of the vehicle. For example, for ease of storage and transport, each vehicle door may be covered by two or three separate panels, each dimensioned to interlock or overlap one another. Further, the quantity of magnetic material contained within the elastomeric layer is selected so as maintain a suitable adhesive force such that the shield panels will not be dislodged when the vehicle is driven at high speed, but may be easily removed by the user.

It is to be understood that the present invention is not limited to the embodiment described above, but encompasses any and all embodiments within the scope of the following claims.

I claim:

1. A vehicle protection assembly, comprising at least one protective vehicle shield adapted for releasably covering at least a portion of a painted vehicle surface, the at least one protective vehicle shield being formed from a composite material containing a synthetic elastomer having magnetic particles embedded therein.

2. The vehicle protection assembly as recited in claim 1, wherein the at least one protective vehicle shield has opposed first and second surfaces, the magnetic particles being evenly distributed within the synthetic elastomer, the first and second surfaces being alternately magnetically attachable to the painted vehicle surface.

3. The vehicle protection assembly as recited in claim 1, wherein the synthetic elastomer is neoprene.

4. The vehicle protection assembly as recited in claim 1, wherein the magnetic particles are formed from neodymium ferrite.

5. The vehicle protection assembly as recited in claim 1, wherein at least one external surface of the at least one protective vehicle shield has indicia formed thereon.

6. The vehicle protection assembly as recited in claim 1, wherein the synthetic elastomer is water-resistant.

7. The vehicle protection assembly as recited in claim 6, wherein the magnetic particles are formed from a rust-resistant material.

8. A vehicle protection kit, comprising a plurality of protective vehicle shields, each of the protective vehicle shields being dimensioned and configured for releasably covering at least a portion of a distinct painted vehicle surface, each of the shields being formed from a composite material containing a synthetic elastomer having magnetic particles embedded therein.

9. The vehicle protection kit as recited in claim 8, wherein each said protective vehicle shield has opposed first and second surfaces, the magnetic particles being evenly distributed within the synthetic elastomer, the first and second surfaces being alternately attachable magnetically to the painted vehicle surface.

10. The vehicle protection kit as recited in claim 8, wherein the synthetic elastomer is neoprene.

11. The vehicle protection kit as recited in claim 8, wherein the magnetic particles are formed from neodymium ferrite.

12. The vehicle protection kit as recited in claim 8, wherein at least one external surface of each said protective vehicle shield has indicia formed thereon.

13. The vehicle protection kit as recited in claim 8, wherein the synthetic elastomer is water-resistant.

14. The vehicle protection kit as recited in claim 8, wherein the magnetic particles are formed from a rust-resistant material.

15. A vehicle protection assembly, comprising at least one protective vehicle shield adapted for releasably covering at least a portion of a painted vehicle surface, the at least one protective vehicle shield being formed from a composite material containing a synthetic material having a magnetic material embedded therein.

16. The vehicle protection assembly as recited in claim 15, wherein the at least one protective vehicle shield has opposed first and second surfaces, the magnetic material being evenly distributed within the synthetic material, the first and second surfaces being alternately magnetically attachable to the painted vehicle surface.

17. The vehicle protection assembly as recited in claim 15, wherein the synthetic material is neoprene.

18. The vehicle protection assembly as recited in claim 15, wherein the magnetic material is formed from neodymium ferrite.

19. The vehicle protection assembly as recited in claim 15, wherein at least one external surface of the at least one protective vehicle shield has indicia formed thereon.

20. The vehicle protection assembly as recited in claim 15, wherein the synthetic material is elastomeric and water-resistant, and wherein the magnetic material is formed from a rust-resistant material.
